(19) United States
(12) Patent Application Publication
(10) Pub. No.: US 2018/0013377 A1
(43) Pub. Date: Jan. 11, 2018

(54) Mitigating the Effects on Shading in Photovoltaic Cells Using Flow Batteries

(71) Applicant: International Business Machines Corporation, Armonk, NY (US)

(72) Inventors: Kalyan K. Dasgupta, Bangalore (IN); Jagabondhu Hazra, Bangalore (IN); Manikandan Padmanaban, Bangalore (IN); Ashish Verma, Bangalore (IN)

(21) Appl. No.: 15/206,599

(22) Filed: Jul. 11, 2016

(51) Int. Cl. H02S 10/10; H01M 8/20; H01M 8/18

(52) U.S. Cl. CPC H02S 10/10; H01M 8/188; H01M 8/20

(57) ABSTRACT

Methods, systems, and computer program products for mitigating the effects of shading in photovoltaic cells using flow batteries are provided herein. A computer-implemented method includes connecting at least one fuel stack to one or more photovoltaic cells, wherein each fuel stack comprises (i) one or more ports and (ii) one or more electrochemical cells; determining that one or more portions of the one or more photovoltaic cells are impacted by a shading effect; converting chemical energy stored in an electrolytic solution to electrical energy, by interacting the electrolytic solution with the electrochemical cells of each fuel stack connected to the portions of the impacted photovoltaic cells; automatically opening the ports of each fuel stack connected to the one or more portions of the impacted photovoltaic cells; and supplying the electrical energy to the portions of the impacted photovoltaic cells.

### FIELD

The present application generally relates to renewable energy technology, and, more particularly, to photovoltaic cell technology.

### BACKGROUND

Utilization of renewable energy sources (such as, for example, wind energy and solar energy) is increasing in many geographic regions. However, renewable energy sources can be highly unpredictable due to dependency on one or more weather conditions and/or variables. Additionally, when utilization of such renewable energy sources reaches certain levels, intermittency can affect the reliability of a grid (which can result in the curtailment of the utilization of renewable energy sources). Causes of such intermittency for photovoltaic (PV) systems, for example, include cloud movement and/or shading effects. For instance, shading not only reduces the power output of PV systems, but can also adversely affect the lifespan of a PV panel due to reverse biasing.

### SUMMARY

In one embodiment of the present invention, techniques for mitigating the effects of shading in photovoltaic cells using flow batteries are provided. An exemplary computer-implemented method can include connecting at least one fuel stack to one or more photovoltaic cells, wherein each fuel stack comprises (i) one or more ports and (ii) one or more electrochemical cells, determining that one or more portions of the one or more photovoltaic cells are impacted by a shading effect, converting chemical energy stored in an electrolytic solution to electrical energy, by interacting the electrolytic solution with the electrochemical cells of each fuel stack connected to the portions of the photovoltaic cells impacted by the shading effect. Such a method can also include automatically opening one or more of the ports of each fuel stack connected to the one or more portions of the photovoltaic cells impacted by the shading effect, and supplying the electrical energy to the portions of the impacted photovoltaic cells by passing the electrolytic solution (i) from the electrochemical cells of each fuel stack connected to the portions of the impacted photovoltaic cells, (ii) out the opened ports (iii) to the portions of the impacted photovoltaic cells, wherein said supplying comprises (a) compensating for energy not produced, because of the shading effect, by the portions of the impacted photovoltaic cells and (b) re-engaging an electrical path from the portions of the impacted photovoltaic cells to one or more portions of the photovoltaic cells not impacted by the shading effect.

In another embodiment of the invention, an exemplary computer-implemented method can include connecting a set of multiple fuel stacks to an array of photovoltaic cells, wherein each of the multiple fuel stacks comprises (i) one or more ports and (ii) one or more electrochemical cells, and wherein each of the multiple fuel stacks is further connected to one or more containers comprising an electrolytic solution. Such a method can also include determining that one or more of the photovoltaic cells within the array are impacted by a shading effect, ensuring that the ports of each of the fuel stacks connected to the one or more photovoltaic cells impacted by the shading effect are open, and ensuring that the ports of each of the fuel stacks connected to the one or more photovoltaic cells not impacted by the shading effect are closed. Further, such a method can include supplying energy to the one or more photovoltaic cells impacted by the shading effect by passing the electrolytic solution (i) from the one or more containers, (ii) through the electrochemical cells of each of the fuel stacks connected to the photovoltaic cells impacted by the shading effect, (iii) out the opened ports of the fuel stacks (iv) to the photovoltaic cells impacted by the shading effect, wherein said supplying comprises (a) compensating for energy not produced, because of the shading effect, by the photovoltaic cells impacted by the shading effect and (b) re-engaging an electrical path from the photovoltaic cells impacted by the shading effect to one or more of the photovoltaic cells not impacted by the shading effect.

Another embodiment of the invention or elements thereof can be implemented in the form of an article of manufacture tangibly embodying computer readable instructions which, when implemented, cause a computer to carry out a plurality of method steps, as described herein. Furthermore, another embodiment of the invention or elements thereof can be implemented in the form of an apparatus including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an exemplary embodiment of the invention;

FIG. 2 is a diagram illustrating system architecture, according to an exemplary embodiment of the invention;

FIG. 3 is a flow diagram illustrating techniques according to an embodiment of the invention;

FIG. 4 is a flow diagram illustrating techniques according to an embodiment of the invention; and

FIG. 5 is a system diagram of an exemplary computer system on which at least one embodiment of the invention can be implemented.

### DETAILED DESCRIPTION

As described herein, an embodiment of the present invention includes mitigating the effects of shading in photovoltaic cells using flow batteries. As noted herein, the complete shading or partial shading of PV modules in a solar array can lead to a reduction of output power as well as the generation of heat due to reverse bias voltage appearing across the shaded portion of the cells. Such a hotspot can block the flow of current from healthy cells and can damage the shaded cell and degrade the entire solar module. Accordingly, one or more embodiments of the invention include compensating for the voltage and power reduction caused by shading effects, and supplying a required level power (for example, a small amount) to remove any blockage from shaded cells. This helps to extract the trapped power from the healthy cells, and also helps to smoothen the solar PV output due to cloud movements.

As further detailed herein, solar panels often include multiple cells which are connected in series and parallel. Accordingly, if one of the cells in a string is shaded, a blockage can be created for the entire sting which blocks the flow of current through the remaining cells. Hence, a significant amount of power can become trapped inside the shaded cells (due to the fact that they are shaded). At least one embodiment of the invention includes remedying such blockages by supplying an (relatively small) amount of power from a flow battery to the shaded cell(s), which helps to extract the trapped power, which can be significantly higher than the power being taken from the flow battery. Such a mechanism can, for example, increase the yield of the solar farm and reduce the variability of PV output due to shading effects.

In at least one embodiment of the invention, a flow battery can be implemented to convert chemical energy stored in an electrolyte to electrical energy. As detailed herein, a flow battery is an electrochemical storage device which can store and delivers energy into and from an electrolytic solution when the solution flows through an electrochemical cell of the flow battery. This can occur via oxidation and reduction reactions, resulting in charging and/or discharging of the flow battery. Oxidation refers to the process of releasing electrons, and reduction refers to the process of gaining electrons. During the discharging process, a free electron is released by the oxidation reaction from the higher potential negative electrode of the electrochemical cell. This free electron flows through the external circuit (wherein the load can be connected to do useful work) and is accepted by the lower potential positive electrode through the reduction reaction. Thus, the difference in chemical potential between the two active electrodes determines the voltage generated by the flow cell. During charging, the chemical reactions are reversed and the external electrical energy is converted into chemical energy (to be stored in an electrolytic solution).

Additionally, one or more embodiments of the invention can include generating and/or constructing a fuel stack of a flow battery in parallel with the individual cells of a PV array or externally connected in parallel with a PV array. Such an embodiment can also include discharging and charging the fuel stack, as further detailed herein.

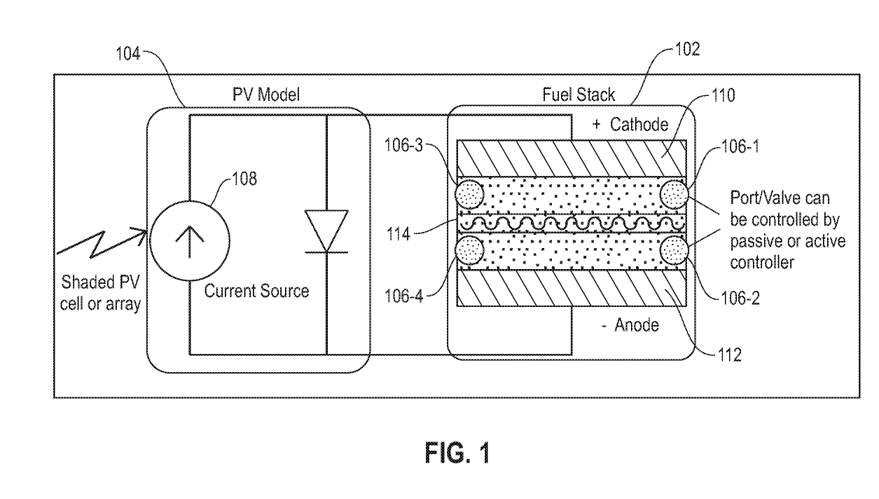

FIG. 1 is a diagram illustrating system architecture, according to an embodiment of the invention. By way of illustration, FIG. 1 depicts a fuel stack 102 to be fabricated in conjunction with a PV cell and/or a PV array 104. The PV array can be modelled as a current source 108, while the fuel stack 102 can include ports/valves 106-1, 106-2, 106-3 and 106-4 (collectively referred to herein as ports/valves 106), a cathode electrode 110, an anode electrode 112, and an ion exchange membrane 114. The ports/valves 106-1, 106-2, 106-3 and 106-4 control the entry and exit of the catholytic and anolytic solution into the fuel stack. The proton ion exchange membrane 114 maintains the chemical equilibrium by providing the passage for hydrogen ions during the oxidation-reduction reactions. The opening of port/valves by a controller allows the electrolytic solution to pass through the electrodes in the fuel stack 102, wherein the solution undergoes oxidation-reduction reactions and produces free electrons. By fabricating the fuel stack 102 in parallel with PV cell/array 104, the produced free electrons are in a position to compensate the power/energy which are supposed to be produced by the PV cell/array 104.

During a shaded period and/or condition, the loss of power due to the shaded portion of a cell or an array can be compensated for by opening the port/valve of the corresponding discharging fuel stack. Accordingly, the fuel stack can supply the deficit amount of voltage and power. Consequently, such an approach includes utilizing unshaded PV cells in the partially shaded array and compensating for the shaded portion of cells. PV cell voltage can be matched by controlling the flow of electrolyte into the fuel stack. Thus, a flow battery stack fabricated in parallel with the PV cell/array, along with one or more controllers (passive and/or active controllers) can be implemented to mitigate the effects of shading without any reduction in output power.

As further described herein, at least one embodiment of the invention includes automatically controlling the opening and closing of one or more fuel stack ports and/or valves to activate and/or deactivate the fuel stack to compensate for one or more shaded portions of a PV cell and/or array via the use of one or more controllers. For example, in one or more embodiments of the invention, cell-level distributed power sources can be controlled by one or more active controllers (using an optimization algorithm, for example) and/or one or more passive controllers (using reverse bias voltage information, for example). Whenever the PV cells in a string are partially shaded, the voltage generated by the non-shaded cells can appear across the shaded cells as reverse bias voltage. Additionally, the reverse bias voltage across the shaded cells can be used by the passive controllers to trigger the opening and closing of the valves/ports of the fuel stack, which are connected in parallel with the PV cells.

Passive controllers can include solenoid valves that can be integrated to operate automatically whenever the reverse bias voltage across the shaded cell can be used to control the opening and closing of the fuel stack (for example, when the voltage across the PV cell crosses a predefined threshold). One or more embodiments of the invention can include implementing solenoid valves, which are electromechanically operated valves, wherein the opening and closing actions are controlled by external current. In such an embodiment, a solenoid valve can be configured to open and close the fuel stack port/valve based on a reverse bias voltage generated by the non-shaded cells on the shaded cells in the PV array that exceeds the pre-defined threshold.

Additionally, active controllers can be optimization based, wherein such a controller opens and/or closes a fuel stack by minimizing the difference in terminal array voltage from a reference voltage by considering and/or leveraging one or more constraints. Such constraints can include, for example, the flow of electrolytes, as well as a balancing of the energy and power available in the flow battery and the needed power/energy to compensate the shaded cells. Active controllers can be well suited in situations wherein there is limited available flow battery power and energy resources (limited fuel stack and electrolytic solution, for instance) to compensate for all of the shaded cells. In other words, if the amount of power or energy required to compensate for the shaded cells is less than the actual requirement, the optimization-based active controllers can be used to compensate for the optimal number of shaded cells to minimize the impact of the shading effects. The formulated optimization problem can yield the optimal number of shaded cells to be opened by minimizing the difference in string terminal voltage from the configured reference voltage for the given power and energy constraints.

As also detailed herein, at least one embodiment of the invention can include maintaining uniform voltage across a PV cell and/or a PV array via utilization of at least one flow battery implemented in parallel to PV cell and/or the PV array. Such an embodiment can include extracting power trapped in (and/or due to) unshaded cells of a partially shaded array via use of a fuel stack of flow batteries. For example, in one or more embodiments of the invention, an amount of power is provided by the fuel stack of the flow battery to compensate for the shaded cells in the partially shaded array, wherein the provided amount of power creates an electrical path to extract the trapped power and maintain uniform voltage across the solar array. In a partially shaded array, shaded cells will block the power generated by the non-shaded or healthy cells (non-shaded cells will be reverse biased and, in turn, the shaded cells can block the electrical path for the entire PV string). Thus, the opening of the fuel stack across the shaded cells will not only provide an electrical path but will also compensate the power not produced by the shaded cells.

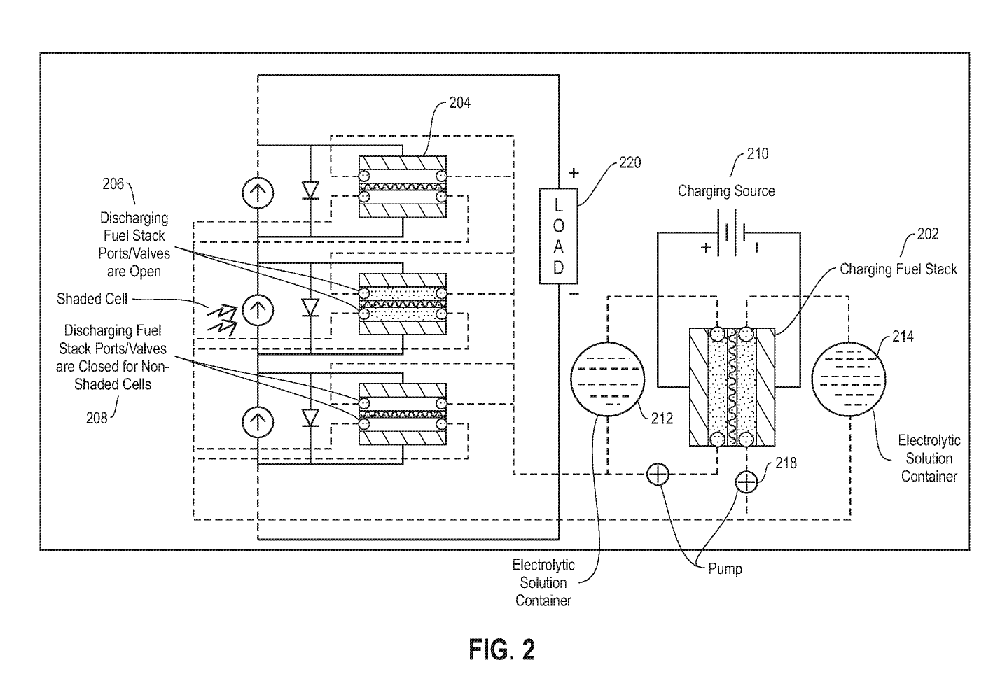

FIG. 2 is a diagram illustrating system architecture, according to an exemplary embodiment of the invention. By way of illustration, FIG. 2 depicts a charging fuel stack 202, which is connected to a charging source 210, electrolyte solution containers 212 and 214, as well as pumps 216 and 218. The charging source 210 can be the external power source to charge the electrolytic solution or replace the existing solution with new electrolytic solution. Further, the charging fuel stack 202 is connected to a collection of discharging fuel stacks 204, 206 and 208, which are connected to a load 220. Specifically, as depicted in FIG. 2, fuel stacks 204 and 208 are discharging fuel stacks that have their ports/valves closed due to an association with one or more non-shaded cells of a PV array. Additionally, fuel stack 206 is a discharging fuel stack that has its ports/valves open due to an association with one or more shaded cells of the PV array.

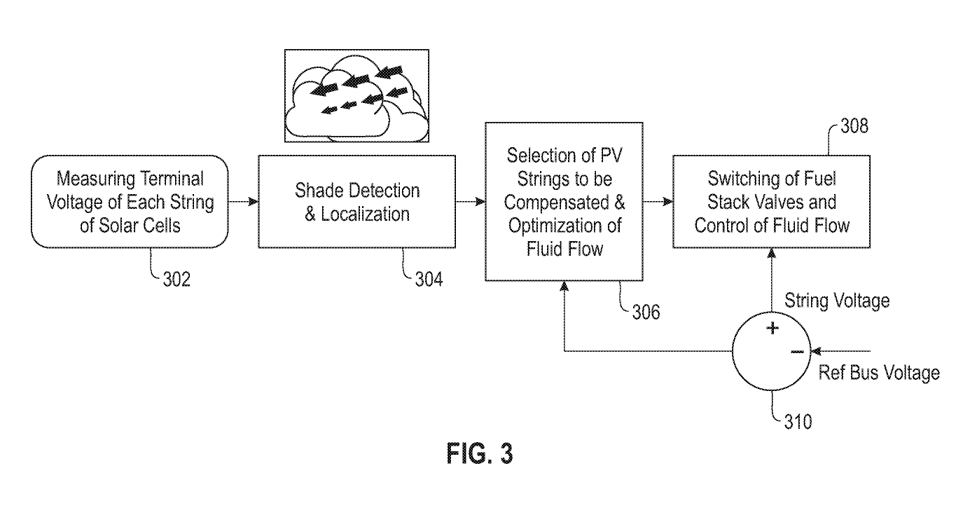

FIG. 3 is a flow diagram illustrating techniques according to an embodiment of the present invention. Specifically, FIG. 3 depicts techniques carried out by an active controller in accordance with one or more embodiments of the invention. Step 302 includes measuring the terminal voltage of each string of solar cells in a PV array. A voltage measuring device can be used to measure the voltage across every string of solar cells. If more than one string is connected in parallel, a current sensor can be used to identify the shaded PV string. Step 304 includes carrying out shade detection and localization (with respect to the PV array) based on the measured terminal voltages. By way of example, during normal operation, the voltage developed across a string of solar cells can be equal to the sum of a diode forward biased voltage drop developed across each cell. When a cell is shaded, this voltage across the string drops.

Step 306, carried out by an optimization component, includes selecting one or more of the PV strings to be compensated (based on the shading detection and localization) and optimizing a fluid flow to carry out the compensation. Optimization of the amount of flow of electrolyte to the strings can be based on an objective function that minimizes the difference in the sum of the voltages across the non-shaded cells and the reference voltage. This ensures that the power produced by the entire set of solar panels is optimal given the quantity of available electrolytes.

Step 308 includes switching and/or managing fuel stack ports/valves and controlling fluid flow with respect to the PV array based on the selection of PV strings. In one or more embodiments of the invention, the port/valve management can be carried out by an independent central processing unit (CPU), acting as the active controller (which does not involve manual intervention). Additionally, referring again to FIG. 3, component 310 is a comparator that compares the string voltage to a fixed reference voltage. In the event of shading, the string voltage drops drastically below the reference voltage.

An objective of an embodiment of the invention such as depicted in FIG. 3 can be denoted as min Σⱼ₌₁^{l}[Σᵢ₌₁^{sc}uᵢⱼvᵢⱼ+Σᵢ₌₁^{nSC}vᵢⱼ−V_{ref}]. Constraints related to such an objective can include a power balance constraint, which is denoted as Σⱼ₌₁^{l}Σᵢ₌₁^{SC}uᵢⱼ×pᵢⱼ≦P; an energy balance constraint, which is denoted as ∫Σⱼ₌₁^{l}Σᵢ₌₁^{SC}uᵢⱼ×pᵢⱼ≦∫P; and an electrolyte flow constraint, which is denoted as Lᵢ≦Lᵢ^{cap} ∀ i in line; wherein l represents the list of shaded string, sc represents a shaded cell, nsc represents a non-shaded cell, vᵢⱼ represents cell voltage, pᵢⱼ represents injected power, and P represents available power.

As detailed herein, at least one embodiment of the invention can include discharging and charging a generated fuel stack. Discharging the fuel stack can include supplying the energy to compensate for a PV cell or array when the port and/or valve of the fuel stack is opened for the passage of an electrolytic solution. Also, charging the flow battery can include externally placing the fuel stack electrically connected to the external power supply to charge the electrolytic solution or replace the existing electrolytic solution. In one or more embodiments of the invention, the electrolytic solution can be placed at elevated position with respect to the charging external fuel stack for easy flow of electrolytes, or the solution can be pumped by an external pump.

As noted herein, at least one embodiment of the invention can include utilizing an electrolytic solution to act as a coolant to absorb heat produced by PV arrays. Such electrolytic solutions can have a higher efficiency when the electrolytes are maintained within a given temperature range (for example, between 40-65 degree Celsius). Accordingly, in accordance with one or more embodiments of the invention, the heat produced by a PV cell/array can be used to operate a flow battery at a high level of efficiency. Also, in at least one embodiment of the invention, an electrolytic solution container can be placed at an elevated position (with respect to the PV cell/array) to facilitate the flow of electrolytes to the stacks. Further, as detailed herein, the external charging fuel stack can be used as an auxiliary energy management unit, and such a stack can also be utilized to equalize the voltage difference across the solar/PV cells/arrays to reduce mismatch losses.

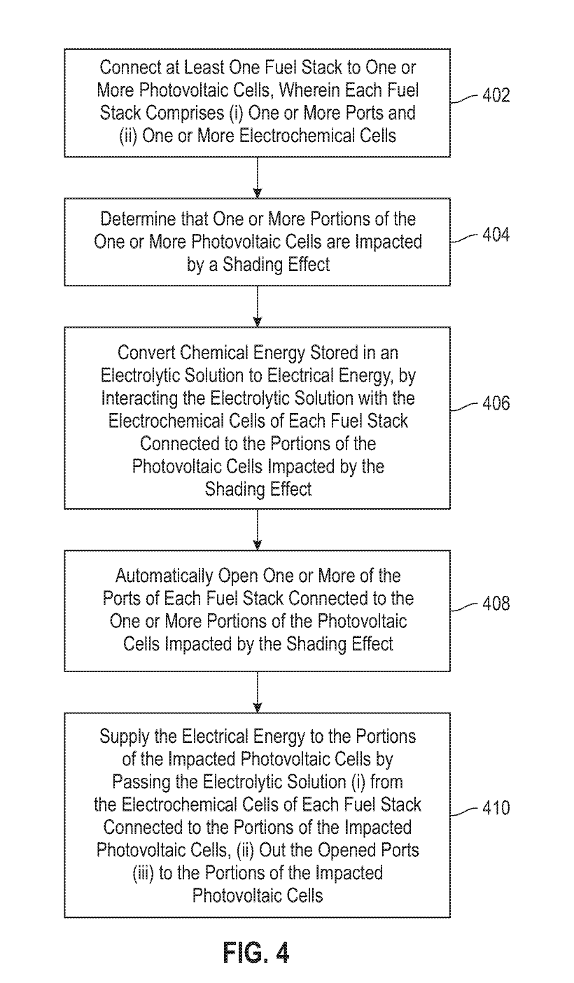

FIG. 4 is a flow diagram illustrating techniques according to an embodiment of the present invention. Step 402 includes connecting at least one fuel stack to one or more photovoltaic cells, wherein each fuel stack comprises (i) one or more ports and (ii) one or more electrochemical cells. The connecting step can include connecting the at least one fuel stack to the one or more photovoltaic cells in a parallel positioning.

Step 404 includes determining that one or more portions of the one or more photovoltaic cells are impacted by a shading effect. At least one embodiment of the invention can also include measuring a terminal voltage of each of the one or more photovoltaic cells. In such an embodiment, the determining step can be based on the terminal voltage of each of the one or more photovoltaic cells. Step 406 includes converting chemical energy stored in an electrolytic solution to electrical energy, by interacting the electrolytic solution with the electrochemical cells of each fuel stack connected to the portions of the photovoltaic cells impacted by the shading effect.

Step 408 includes automatically opening one or more of the ports of each fuel stack connected to the one or more portions of the photovoltaic cells impacted by the shading effect. Also, automatically opening one or more ports comprises automatically opening one or more of the ports of each fuel stack upon a determination that a voltage measurement (for example, a reverse bias voltage measurement) derived from the one or more photovoltaic cells linked to the fuel stack crosses a pre-defined threshold. Additionally, automatically opening one or more ports can include using an optimization algorithm that minimizes a difference between a terminal voltage measurement of the one or more photovoltaic cells and a reference voltage. Such an optimization algorithm can also consider one or more constraints.

Step 410 includes supplying the electrical energy to the portions of the impacted photovoltaic cells by passing the electrolytic solution (i) from the electrochemical cells of each fuel stack connected to the portions of the impacted photovoltaic cells, (ii) out the opened ports (iii) to the portions of the impacted photovoltaic cells, wherein said supplying comprises (a) compensating for energy not produced, because of the shading effect, by the portions of the impacted photovoltaic cells and (b) re-engaging an electrical path from the portions of the impacted photovoltaic cells to one or more portions of the photovoltaic cells not impacted by the shading effect. Further, at least one embodiment of the invention can also include charging the electrolytic solution.

The techniques depicted in FIG. 4 can additionally include automatically closing one or more of the ports of a second fuel stack, wherein the second fuel stack is linked to one or more of the photovoltaic cells not impacted by the shading effect. Further, the techniques depicted in FIG. 4 can also include controlling the amount of energy supplied through the one or more opened ports by controlling the opening and the closing of the one or more ports of each fuel stack.

Also, an additional embodiment of the invention includes connecting a set of multiple fuel stacks to an array of photovoltaic cells, wherein each of the multiple fuel stacks comprises (i) one or more ports and (ii) one or more electrochemical cells, and wherein each of the multiple fuel stacks is further connected to one or more containers comprising an electrolytic solution. Such an embodiment can also include determining that one or more of the photovoltaic cells within the array are impacted by a shading effect, ensuring that the ports of each of the fuel stacks connected to the one or more photovoltaic cells impacted by the shading effect are open, and ensuring that the ports of each of the fuel stacks connected to the one or more photovoltaic cells not impacted by the shading effect are closed. Further, such an embodiment can include supplying energy to the one or more photovoltaic cells impacted by the shading effect by passing the electrolytic solution (i) from the one or more containers, (ii) through the electrochemical cells of each of the fuel stacks connected to the photovoltaic cells impacted by the shading effect, (iii) out the opened ports of the fuel stacks (iv) to the photovoltaic cells impacted by the shading effect, wherein said supplying comprises (a) compensating for energy not produced, because of the shading effect, by the photovoltaic cells impacted by the shading effect and (b) re-engaging an electrical path from the photovoltaic cells impacted by the shading effect to one or more of the photovoltaic cells not impacted by the shading effect.

The techniques depicted in FIG. 4 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 4 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

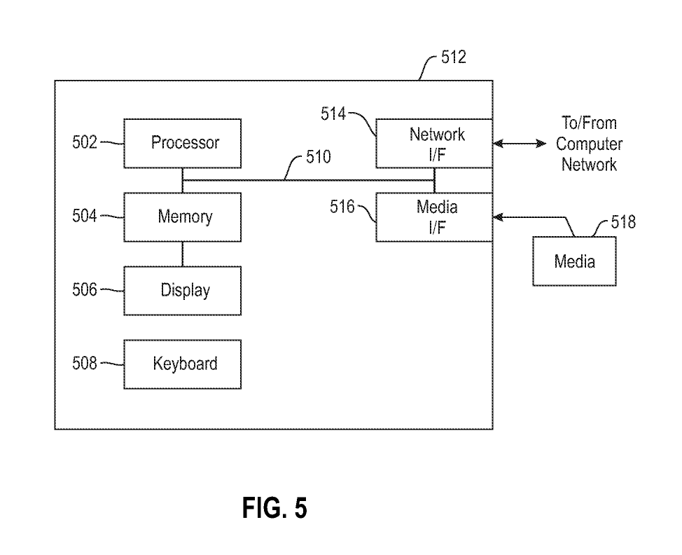

Additionally, an embodiment of the present invention can make use of software running on a computer or workstation. With reference to FIG. 5, such an implementation might employ, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 502. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, compensating for voltage and power reduction caused by the shading of one or more photovoltaic cells, so that a desired level of output power-independent of any shading, is supplied.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
connecting at least one fuel stack to one or more photovoltaic cells, wherein each fuel stack comprises (i) one or more ports and (ii) one or more electrochemical cells;
determining that one or more portions of the one or more photovoltaic cells are impacted by a shading effect;
converting chemical energy stored in an electrolytic solution to electrical energy, by interacting the electrolytic solution with the electrochemical cells of each fuel stack connected to the portions of the photovoltaic cells impacted by the shading effect;
automatically opening one or more of the ports of each fuel stack connected to the one or more portions of the photovoltaic cells impacted by the shading effect; and
supplying the electrical energy to the portions of the impacted photovoltaic cells by passing the electrolytic solution (i) from the electrochemical cells of each fuel stack connected to the portions of the impacted photovoltaic cells, (ii) out the opened ports (iii) to the portions of the impacted photovoltaic cells, wherein said supplying comprises (a) compensating for energy not produced, because of the shading effect, by the portions of the impacted photovoltaic cells and (b) re-engaging an electrical path from the portions of the impacted photovoltaic cells to one or more portions of the photovoltaic cells not impacted by the shading effect;
wherein the steps are carried out by at least one computing device.

2. The computer-implemented method of claim 1, comprising:
measuring a terminal voltage of each of the one or more photovoltaic cells.

3. The computer-implemented method of claim 2, wherein said determining is based on the terminal voltage of each of the one or more photovoltaic cells.

4. The computer-implemented method of claim 1, wherein said connecting comprises connecting the at least one fuel stack to the one or more photovoltaic cells in a parallel positioning.

5. The computer-implemented method of claim 1, wherein said automatically opening one or more ports comprises automatically opening one or more of the ports of each fuel stack upon a determination that a voltage measurement derived from the one or more photovoltaic cells linked to the fuel stack crosses a pre-defined threshold.

6. The computer-implemented method of claim 5, wherein the voltage measurement comprises a reverse bias voltage measurement.

7. The computer-implemented method of claim 1, wherein said automatically opening one or more ports comprises using an optimization algorithm that minimizes a difference between a terminal voltage measurement of the one or more photovoltaic cells and a reference voltage.

8. The computer-implemented method of claim 7, wherein said optimization algorithm considers one or more constraints.

9. The computer-implemented method of claim 1, comprising:
charging the electrolytic solution.

10. The computer-implemented method of claim 1, comprising:
automatically closing one or more of the ports of a second fuel stack, wherein the second fuel stack is linked to one or more of the photovoltaic cells not impacted by the shading effect.

11. The computer-implemented method of claim 1, comprising:
controlling the amount of energy supplied through the one or more opened ports by controlling the opening and the closing of the one or more ports of each fuel stack.

12. A computer program product comprising a computer readable storage medium having program instructions embodied therewith, the program instructions executable by a device to cause the device to:
connect at least one fuel stack to one or more photovoltaic cells, wherein each fuel stack comprises (i) one or more ports and (ii) one or more electrochemical cells;
determine that one or more portions of the one or more photovoltaic cells are impacted by a shading effect;
convert chemical energy stored in an electrolytic solution to electrical energy, by interacting the electrolytic solution with the electrochemical cells of each fuel stack connected to the portions of the photovoltaic cells impacted by the shading effect;
automatically open one or more of the ports of each fuel stack connected to the one or more portions of the photovoltaic cells impacted by the shading effect; and supplying the electrical energy to the portions of the impacted photovoltaic cells by passing the electrolytic solution (i) from the electrochemical cells of each fuel stack connected to the portions of the impacted photovoltaic cells, (ii) out the opened ports (iii) to the portions of the impacted photovoltaic cells, wherein said supplying comprises (a) compensating for energy not produced, because of the shading effect, by the portions of the impacted photovoltaic cells and (b) re-engaging an electrical path from the portions of the impacted photovoltaic cells to one or more portions of the photovoltaic cells not impacted by the shading effect.

13. The computer program product of claim 12, wherein the program instructions executable by a computing device further cause the computing device to:
automatically close one or more of the ports of a second fuel stack, wherein the second fuel stack is linked to one or more of the photovoltaic cells not impacted by the shading effect.

14. A system comprising:
a memory; and
at least one processor coupled to the memory and configured for:
connecting at least one fuel stack to one or more photovoltaic cells, wherein each fuel stack comprises (i) one or more ports and (ii) one or more electrochemical cells;
determining that one or more portions of the one or more photovoltaic cells are impacted by a shading effect;
converting chemical energy stored in an electrolytic solution to electrical energy, by interacting the electrolytic solution with the electrochemical cells of each fuel stack connected to the portions of the photovoltaic cells impacted by the shading effect;
automatically opening one or more of the ports of each fuel stack connected to the one or more portions of the photovoltaic cells impacted by the shading effect; and supplying the electrical energy to the portions of the impacted photovoltaic cells by passing the electrolytic solution (i) from the electrochemical cells of each fuel stack connected to the portions of the impacted photovoltaic cells, (ii) out the opened ports (iii) to the portions of the impacted photovoltaic cells, wherein said supplying comprises (a) compensating for energy not produced, because of the shading effect, by the portions of the impacted photovoltaic cells and (b) re-engaging an electrical path from the portions of the impacted photovoltaic cells to one or more portions of the photovoltaic cells not impacted by the shading effect.

15. The system of claim 14, wherein the at least one processor is further configured for:
automatically closing one or more of the ports of a second fuel stack, wherein the second fuel stack is linked to one or more of the photovoltaic cells not impacted by the shading effect.

16. A computer-implemented method, comprising:
connecting a set of multiple fuel stacks to an array of photovoltaic cells, wherein each of the multiple fuel stacks comprises (i) one or more ports and (ii) one or more electrochemical cells, and wherein each of the multiple fuel stacks is further connected to one or more containers comprising an electrolytic solution;
determining that one or more of the photovoltaic cells within the array are impacted by a shading effect;
ensuring that the ports of each of the fuel stacks connected to the one or more photovoltaic cells impacted by the shading effect are open;
ensuring that the ports of each of the fuel stacks connected to the one or more photovoltaic cells not impacted by the shading effect are closed; and
supplying energy to the one or more photovoltaic cells impacted by the shading effect by passing the electrolytic solution (i) from the one or more containers, (ii) through the electrochemical cells of each of the fuel stacks connected to the photovoltaic cells impacted by the shading effect, (iii) out the opened ports of the fuel stacks (iv) to the photovoltaic cells impacted by the shading effect, wherein said supplying comprises (a) compensating for energy not produced, because of the shading effect, by the photovoltaic cells impacted by the shading effect and (b) re-engaging an electrical path from the photovoltaic cells impacted by the shading effect to one or more of the photovoltaic cells not impacted by the shading effect;
wherein the steps are carried out by at least one computing device.

17. The computer-implemented method of claim 16, wherein said detecting is based on a terminal voltage of each of the one or more photovoltaic cells.

18. The computer-implemented method of claim 16, wherein said connecting comprises connecting the set of multiple fuel stacks in a parallel positioning to the array.

19. The computer-implemented method of claim 16, wherein said automatically opening the ports comprises automatically opening the ports upon a determination that a voltage measurement derived from the one or more photovoltaic cells linked to the fuel stacks crosses a pre-defined threshold.

20. The computer-implemented method of claim 16, wherein said automatically opening the ports comprises using an optimization algorithm that minimizes the difference between a terminal voltage measurement of the photovoltaic cells linked to the fuel stacks and a reference voltage.
